(19) United States
(12) Patent Application Publication
(10) Pub. No.: US 2021/0302157 A1
(43) Pub. Date: Sep. 30, 2021

(54) METHOD, DEVICE AND SYSTEM FOR ANALYZING TUNNEL CLEARANCE BASED ON LASER POINT CLOUD

(71) Applicant: Nanjing University of Aeronautics and Astronautics, Nanjing (CN)

(72) Inventors: Jun WANG, Nanjing (CN); Yuxiang WU, Nanjing (CN); Dening LU, Nanjing (CN)

(21) Appl. No.: 17/169,541

(22) Filed: Feb. 7, 2021

(30) Foreign Application Priority Data
Mar. 25, 2020 (CN) 202010218307.4

(51) Int. Cl. G01C 5/00; G01C 7/06

(52) U.S. Cl. CPC G01C 5/00; G01C 7/06

(57) ABSTRACT

A point cloud of a tunnel is obtained. A cylinder is fitted using the point cloud of the tunnel. A central axis of the tunnel is extracted. A section of the tunnel is intercepted based on the central axis of the tunnel. Point cloud subsets of two rails are extracted. A base line of a contour of the tunnel clearance is constructed. A center of the section of the tunnel is extracted. A point cloud of the section of the tunnel is registered with a point cloud of the tunnel clearance based on a constraint condition. The point cloud of the section of the tunnel and the point cloud of the tunnel clearance which are registered with each other are analyzed to determine whether the tunnel clearance is intruded.

### CROSS-REFERENCE TO RELATED APPLICATIONS

This application claims the benefit of priority from Chinese Patent Application No. 202010218307.4, filed on Mar. 25, 2020. The content of the aforementioned application, including any intervening amendments thereto, is incorporated herein by reference in its entirety.

### TECHNICAL FIELD

The present application relates to tunnel clearance analysis, in particular to a method, a device and a system for analyzing tunnel clearance based on a laser point cloud.

### BACKGROUND

As the rail transit technology rapidly develops, infrastructures of subway tunnels built many years ago are required to be maintained. The newly built subway tunnels may be subjected to deformation due to comprehensive factors, such as geology, groundwater, construction of adjacent foundation pits, and its structural load. This has an inverse impact on the safety of the tunnel and the operation of the trains. Therefore, deformation monitoring must be carried out in a timely and accurate manner to inspect and forecast dangerous situations in time to ensure the safety of tunnel operation. In particular, the results of tunnel deformation analysis and boundary analysis are directly related to the safe operations of trains. If the deformation trend of the subway tunnel is not warned in time, the tunnel will deform. Since the tunnel segments have greater rigidity, when the cylindrical tunnels deform, the tension and compression are exerted at joints of the segments, resulting in fragmentation at both ends of the segments and failure of waterstop, which will further damage the tunnel infrastructure.

Generally, tunnels are manually and visually inspected, which has low efficiency and accuracy, and consumes a lot of manpower and material resources. In recent years, with the expansion of the construction scale of urban subway projects, the 3D laser scanning technology is gradually adopted for the inspection of subway tunnels. The acquired large-scale 3D laser point cloud data contains coordinate information of the tunnel and laser reflectivity information, so that the deformation state of the tunnel surface is accurately reflected. However, the discrete data obtained by the traditional total station measurement has low data integrity and low precision, and subsequent data processing is difficult. The recently emerging rail vehicle system has overcome this problem. The deformation of the tunnel is analyzed through the tunnel point cloud data obtained through vehicle-mounted 3D laser scanning system, so as to take timely measures to deal with the problems that may occur in the subway tunnel. For example, Chinese Patent Publication No. 108731640 A discloses a method and a system for inspecting tunnel clearance based on point cloud data. The method includes the following steps. The measurement data of a tunnel is obtained, where the measurement data includes point cloud data collected by a laser scanner. A cross-sectional view of the tunnel is generated based on the measurement data. Clearance parameters of a subway are obtained, and a clearance diagram of the subway is generated according to the clearance parameters. The clearance diagram is compared to the cross-sectional view, and a clearance analysis result is obtained according to standard parameters of clearance inspection of the subway, so that the clearance of the subway is automatically inspected. Moreover, by using the point cloud data collected by the laser scanner, the three-dimensional full-angle measurement of the subway tunnel space is realized, which improves the inspection accuracy.

In the aforementioned method, the standard parameters of the clearance inspection should be known. In addition, in the scanning process of the subway tunnel, the initial state calibration of the mobile scanning is not strictly perpendicular to the tunnel axis, and the equipment vibrates during the movement. Thus, the subway deformation information and tunnel clearance analysis results cannot be directly obtained through the point cloud data of the scanned subway tunnel, and pre-processing and post-analysis are required for the scanned data. In addition, a expensive inspection device should be built to improve the accuracy of the point cloud data.

Chinese Patent Publication No. 110793501 A discloses an inspection method for tunnel clearance, which overcomes shortcomings of low efficiency and high cost in the intrusion inspection of the tunnel. The point cloud of the tunnel section is obtained through the three-dimensional laser scanning device, and the circumscribed rectangular frame of the point cloud of the tunnel section is generated. The point cloud of the tunnel section in the rectangular frame is converted into a cross-sectional image. Feature points of the tunnel in the cross-sectional image are marked to obtain a sample set. A regression model is built based on convolutional neural network, and is trained and tested through the sample set obtained by marking. Then, predictions are made through the regression model. The contour line of the rail vehicle is obtained, and feature points are obtained to unify the coordinates of the rail vehicle and the coordinate of the point cloud of the tunnel section, and then they are superimposed. Whether the rail vehicle intrudes the clearance of the tunnel is determined based on the regression model. This method can unify the coordinate system of the rail vehicle and the point cloud of the cross section of the tunnel through model calculation, so that the intrusion can be efficiently and conveniently judged. However, a large amount of sample data is required for the regression model, and the calculation process is complicated. In addition, different models should be recreated for tunnels of different structures, and the method has low accuracy and efficiency. Thus, it cannot meet the requirements of modern tunnel inspection and monitoring.

There is no method to determine whether the tunnel section intrudes the tunnel clearance.

### SUMMARY OF THE DISCLOSURE

The present disclosure aims to provide a method, a device and a system for analyzing tunnel clearance based on a laser point cloud. After the extraction of the point cloud subsets of rails, a base line of a contour of the tunnel clearance is constructed, and a point cloud of a tunnel section is registered with the point cloud of the tunnel clearance based on constraint conditions. Then, the registered data is analyzed to quickly determine the intrusion situation. The initial state of the mobile scanning is not required to be strictly perpendicular to the tunnel axis. The method has strong robustness, in which data noise is allowed in the analysis process. In addition, after the extraction of the point cloud subset, the base line of the contour of the tunnel clearance is constructed, and the point cloud of a tunnel section is registered with the point cloud of the tunnel clearance based on constraint conditions, which can accurately obtain the relative position relationship between the tunnel clearance and the section of the tunnel, so that the intrusion is quickly determined. The method has high judgment accuracy and is not limited to a specific structure tunnel, so it has strong applicability.

In view of the above objects, the present disclosure provides a method for analyzing tunnel clearance based on a laser point cloud, comprising:

A method for analyzing tunnel clearance based on a lase point cloud, comprising:

1) obtaining a point cloud of a tunnel;

2) fitting a cylinder using the point cloud of the tunnel; extracting a central axis of the tunnel; and intercepting a section of the tunnel based on the central axis of the tunnel;

3) extracting point cloud subsets of two rails;

4) constructing a base line of a contour of the tunnel clearance; and extracting a center of the section of the tunnel; and registering a point cloud of the section of the tunnel with a point cloud of the tunnel clearance based on a constraint condition; and

5) analyzing the point cloud of the section of the tunnel and the point cloud of the tunnel clearance which are registered with each other to determine whether the tunnel clearance is intruded.

In some embodiments, the step 1 comprises:

scanning the tunnel using a three-dimensional laser scanner to obtain the point cloud of the tunnel; and

intercepting the point cloud of the tunnel in sections.

In some embodiments, each section containing 10 rings.

In some embodiments, the step 2 comprises:

21) fitting a cylinder using the point cloud of the tunnel through Gaussian mapping to extract a central axis of the tunnel;

22) intercepting the point cloud of a single section of the tunnel based on a point p in the point cloud and an axis direction of the point to construct a section plane; and

23) projecting the point cloud of the section of the tunnel along the extracted central axis of the tunnel to obtain two-dimensional section data.

In some embodiments, the step 3 comprises:

extracting point clouds of the two rails from the point cloud of the tunnel;

selecting points pᵢ and pⱼ from point clouds of the two rails; and

clustering point cloud subsets of the two rails using Euclidean distance.

In some embodiments, the constraint condition in the step 4 is obtained is obtained by steps of:

selecting the highest points z_maxᵢ and z_maxⱼ of the point clouds of the two rails to construct a straight line l; calculating a slope k of the straight line l;

fitting a circle using Random Sample And Consensus (RANSAC) method according to the point cloud of the section of the tunnel to obtain a center c of the circle and an abscissa c·x of the center of the circle; and

setting two constraint conditions: a) a bottom edge of a bound box of a clearance contour coincides with the straight line l; and b) an abscissa c₀·x of a center of the clearance contour is the abscissa c·x of the center of the circle.

In some embodiments, the step 5 comprises:

for a point p_i in the center of the point cloud of the tunnel section, searching the closest point p_in in the point cloud of the clearance contour through K-NearestNeighbor (KNN); and determining whether the tunnel clearance is intruded. through an intrusion function:

S=∥p_i−c∥−∥p_in−c∥,

wherein, p_i is any point in the point cloud of the section of the tunnel; p_in is the closest point searched by k-nearest neighbors (KNN) algorithm in the point cloud of the clearance contour; when S<0, the tunnel clearance is intruded; otherwise, the tunnel clearance is not intruded.

The present disclosure provides a device for analyzing tunnel clearance based on a laser point cloud, comprising:

a data acquisition module, configured to acquire a point cloud of a tunnel;

a preprocessing module, configured to pre-process the point cloud of the tunnel, intercept segments, and extract a central axis of the tunnel and point cloud subsets of a rail; wherein the point cloud subsets are for registration of the point cloud; and

an analysis module, configured to calculate a straight line and a center of the tunnel, and register a point cloud of a clearance contour with a point cloud of a section of the tunnel through constraint conditions to analyze the tunnel clearance.

In some embodiments, the preprocessing module comprises:

an interception unit, configured to intercept the point cloud of the tunnel into segments; and

an extraction unit, configured to extract the point cloud subsets of the rails from the point cloud of the tunnel and and perform clustering for the point cloud subsets of the two rails using Euclidean distance, so as to extract the point cloud subsets of the two rails.

The present disclosure provides a system for analyzing tunnel clearance based on a laser point cloud, comprising:

a three-dimensional scanner;

a processor;

a storage; and

a program, stored on the storage, for executing the method as disclosed herein;

wherein the system is mounted on a tunnel inspection vehicle; and

the three-dimensional scanner is connected to the processor, and is configured to scan the tunnel to obtain point cloud of the tunnel and send the obtained point cloud of the tunnel to the processor.

The present disclosure provides an accurate and automatic inspection calculation method to analyze the tunnel clearance. Specifically, a three-dimensional point cloud of the subway tunnel is obtained, and the data of sections is intercepted. A cylinder is fitted, and a central axis of the cylinder is extracted. The point cloud of the two-dimensional section of the tunnel is projected. Point cloud subsets of the rails are extracted, and the constraint conditions are calculated. Finally, the clearance intrusion is calculated through registration. The above method can simply and effectively inspect the clearance intrusion problem of the subway tunnel, can more effectively reduce the operation risk of the train, and improve the safety of the train operation.

Compared to the prior art, the technical solutions of the present disclosure have the following beneficial effects.

1) The initial state of the mobile scanning is not required to be strictly perpendicular to the tunnel axis. The method has strong robustness, in which data noise is allowed in the analysis process.

2) After the extraction of the point cloud subset, the base line of the contour of the tunnel clearance is constructed, and the point cloud of a tunnel section is registered with the point cloud of the tunnel clearance based on constraint conditions, which can accurately obtain the relative position relationship between the tunnel clearance and the section of the tunnel, so that the intrusion is quickly determined. The method has high judgment accuracy and is not limited to a specific structure tunnel, so it has strong applicability.

It should be understood that all combinations of the aforementioned concepts and the additional concepts described in detail below can be regarded as part of the subject matter of the present disclosure unless conflicted. In addition, all combinations of the subject matter are regarded as part of the subject matter of the present disclosure.

The present disclosure will be described below with reference to the embodiments and the accompanying drawings, from which features and beneficial effects of the present disclosure will be clear.

### BRIEF DESCRIPTION OF THE DRAWINGS

The drawings are illustrative in nature and are not drawn to scale. Throughout the drawings, like reference numerals refer to identical or functionally similar elements. For clarity, not every component is labeled in every figure. The embodiments of the present disclosure are illustrated below with reference to the accompanying drawings.

FIG. 1 is a flowchart of a method for analyzing tunnel clearance based on laser point clouds according to at least one embodiment of the present disclosure.

FIG. 2 is a schematic diagram of a point cloud of a segment containing 10 rings obtained by using the method according to at least one embodiment of the present disclosure.

FIG. 3 is a schematic diagram of a point cloud of rails in a section of the tunnel according to at least one embodiment of the present disclosure.

FIG. 4 shows results of the clearance analysis of the tunnel using the method according to at least one embodiment of the present disclosure.

FIG. 5 is a schematic diagram of a device for analyzing tunnel clearance based on laser point clouds according to at least one embodiment of the present disclosure.

### DETAILED DESCRIPTION OF EMBODIMENTS

The embodiments of the present disclosure will be described in detail below with reference to the accompanying drawings, from which technical solutions of the present disclosure become clear.

### Embodiment 1

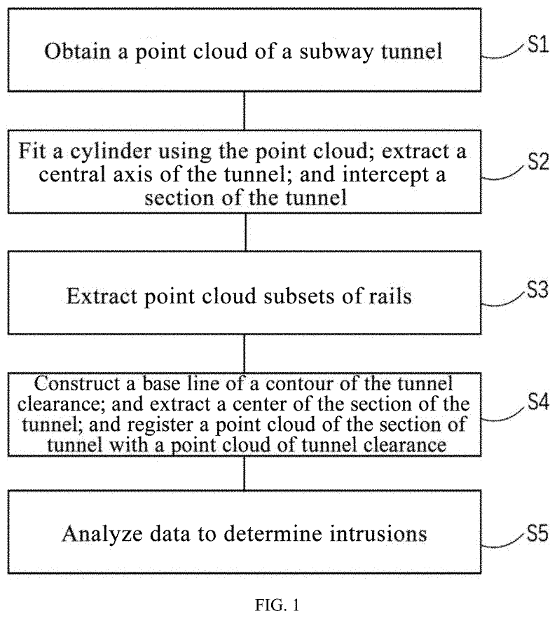

This embodiment illustrates a method for analyzing tunnel clearance based on laser point clouds, which can be directly applied to various laser point clouds based clearance analysis devices of subway tunnels. In specific implementation, the application can be realized by writing corresponding programs in controllers of clearance analysis device of the subway tunnel. As shown in FIG. 1, the method includes the following steps.

1) A point cloud of a subway tunnel is obtained. Specifically, the tunnel is scanned by a three-dimensional scanner based tunnel inspection vehicle to obtain the point cloud of the subway tunnel.

2) A cylinder is fitted using the point cloud of the tunnel. A central axis of the tunnel is extracted. A section of the tunnel is intercepted based on the central axis of the tunnel. Specifically, the cylinder is fitted using the point cloud through Gaussian mapping. The central axis of the subway tunnel is extracted, and the point cloud data of a single section of a tunnel is intercepted. A section plane is constructed based on a point p in the point cloud and the axis direction of the point.

3) Point cloud subsets of rails are extracted. Specifically, point pᵢ and point pⱼ are respectively selected from the point clouds of the two rails. The point cloud subsets of the two rails are clustered using Euclidean distance. A threshold of clustering distances is set to 0.02 m, and the point cloud subset of the rail is extracted.

4) A base line of a contour of tunnel clearance is constructed, and a center of the section of the tunnel is extracted. The point cloud of the section of the tunnel is registered with the point cloud of the tunnel clearance based on constraint conditions. Specifically, the highest points z_maxᵢ and z_maxⱼ of the point clouds of the two rails are selected to construct a straight line l, and a slope k of the straight line l is calculated. A circle is fitted for the section of the tunnel using Random Sample And Consensus (RANSAC) method, and a threshold of the RANSAC bandwidth set to 0.04 m, and a circle center c is obtained. The point cloud of the contour of the tunnel clearance is registered with the point cloud of the tunnel section, in which the following two constraint conditions should be satisfied. One is that a bottom edge of a bounding box of a clearance contour coincides with the straight line l. The other constraint is that an abscissa of a center of the clearance contour c0·x is the abscissa c·x of the center of the circle.

5) Data analysis is carried out to determine the invasion. Specifically, for any point p_i in the center of the point cloud of the tunnel section, the closest point p_in in the point cloud of the clearance contour is searched through KNN, and then whether the clearance is intruded is judged by an intrusion function. The intrusion function is defined as:

S=∥p_i−c∥−∥p_in−c∥,

where, p_i is any point in the point cloud of the tunnel section; p_in is the closest point searched by KNN in the point cloud of the clearance contour; when S<0, the tunnel clearance is intruded; otherwise, the tunnel clearance is not intruded.

In this embodiment, an accurate calculation and analysis method is provided to determine whether the tunnel intrudes the clearance contour. Specifically, the point cloud of a subway tunnel is obtained. A cylinder is fitted using the point cloud of the tunnel. The central axis of the tunnel is extracted. The section of the tunnel is intercepted based on the central axis of the tunnel. A point cloud subset of a rail is extracted. The base line of a clearance contour is constructed, and the center of the section of the tunnel is extracted. The point cloud of the section of the tunnel is registered with the point cloud of the tunnel clearance based on constraint conditions. Data analysis is carried out to determine the intrusion. The above method is a simple and feasible method for clearance analysis of subway tunnels, which can effectively reduce the difficulty in the clearance analysis of subway tunnel, avoid analysis errors caused by complex analysis and calculation, and improve the efficiency and accuracy of the clearance analysis.

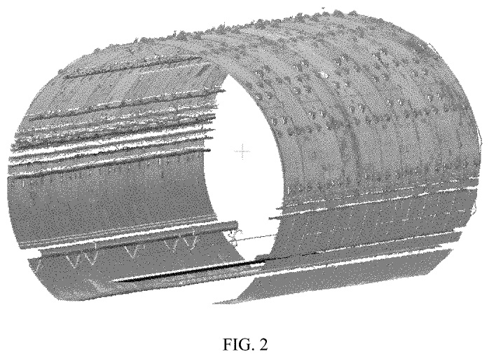

FIG. 2 is a schematic diagram of a point cloud of a segment containing 10 rings obtained by using the method of the present disclosure. The tunnel is scanned by a three-dimensional scanner based tunnel inspection vehicle to obtain the point cloud of the subway tunnel. In this embodiment, the point cloud of the subway tunnel is the point cloud of the segment containing 10 rings.

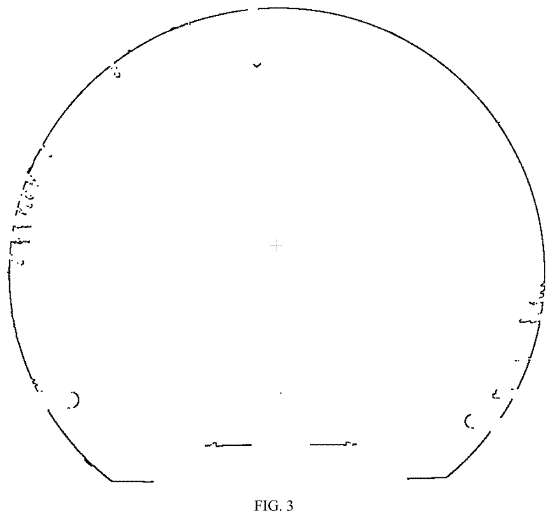

FIG. 3 is a schematic diagram of a point cloud of rails in a section of the tunnel. Specifically, the point pᵢ and the point pⱼ are respectively selected from the point clouds of the two rails. The point cloud subsets of the two rails are clustered using Euclidean distance. A threshold of clustering distances is set to 0.02 m, and the point cloud subset of the rail is extracted. The point cloud data in the wireframe shown in FIG. 3 is the extracted point cloud subsets of the two rails.

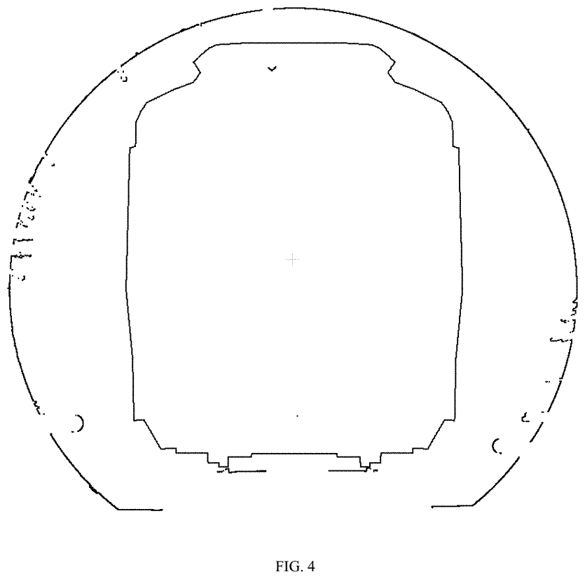

FIG. 4 shows the result of the clearance analysis of the tunnel using the method of this embodiment, in which the distance between the clearance contour and the closest point of the section of the tunnel is calculated and displayed. The method of the present disclosure can accurately analyze the tunnel clearance and inspect the clearance intrusion of subway tunnels.

### Embodiment 2

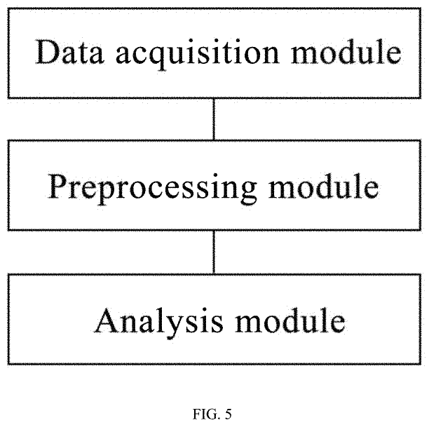

Based on the method for analyzing tunnel clearance based on the laser point cloud, this embodiment provides a device for analyzing tunnel clearance based on a laser point cloud. Specifically, FIG. 2 shows an optional structural diagram of the device. As shown in FIG. 5, the device includes a data acquisition module, a preprocessing module, and an analysis module.

The data acquisition module is configured to acquire 3D point cloud data of a subway tunnel. The subway tunnel is scanned through a tunnel detection vehicle based 3D laser scanner system, and 3D point cloud data of the subway tunnel is exported for subsequent preprocessing and analysis calculation.

The preprocessing module is connected to the data acquisition module, and is configured to pre-process the point cloud data of the subway tunnel, intercept the segment, and extract the central axis of the tunnel and the point cloud subsets of rails. The preprocessing module includes an interception unit and an extraction unit. The interception unit is configured to intercept the point cloud data for segments containing 10 rings, which is convenient for subsequent batch processing. The extraction unit is configured to extract the point cloud subsets of the rails from the point cloud data of the tunnel, and perform clustering for the point cloud subsets of the two rails using Euclidean distance, so as to extract the point cloud subsets of the two rails.

The analysis module is connected to the preprocessing module, and is configured to calculate a straight line and a center of the tunnel, and register the point cloud of the clearance contour with the point cloud of the section of the tunnel through constraint conditions to carry out the clearance analysis.

In this embodiment, an accurate calculation and analysis method is provided to determine whether the tunnel intrude the clearance contour. Specifically, the point cloud of a subway tunnel is obtained. A cylinder is fitted using the point cloud of the tunnel. The central axis of the tunnel is extracted. The section of the tunnel is intercepted based on the central axis of the tunnel. A point cloud subset of a rail is extracted. The base line of a clearance contour is constructed, and the center of the section of the tunnel is extracted. The point cloud of the section of the tunnel is registered the point cloud of the tunnel clearance based on constraint conditions. Data analysis is carried out to determine the invasion. The above method is a simple and feasible method for clearance analysis of subway tunnels, which can effectively reduce the difficulty in the clearance analysis of subway tunnel, avoid analysis errors caused by complex analysis and calculation, and improve the efficiency and accuracy of the clearance analysis.

In some embodiments, the preprocessing module includes an interception unit and an extraction unit. The interception unit is configured to intercept the point cloud data into segments containing 10 rings, which is convenient for subsequent batch processing. The extraction unit is configured to extract the point cloud subsets of the rails from the point cloud data of the tunnel, and perform clustering for the point cloud subsets of the two rails using Euclidean distance, so as to extract the point cloud subsets of the two rails.

In some embodiments, the analysis module includes: a constraint calculation unit, a point cloud registration unit and an intrusion calculation unit. The constraint calculation unit is configured to construct the characteristic straight line of the rail and fit a circle through RANSAC, and calculate the slope of the straight line and the constraint conditions such as the center of the tunnel. The point cloud registration unit, based on the above constraints, the clearance contour is registered with the point cloud of the section of the tunnel. The intrusion calculation unit is configured to determine whether the segments of the tunnel intrude the tunnel clearance using the defined intrusion function.

The above embodiments are illustrative of the present disclosure and not intended to limit the scope of the present disclosure. Various modifications and changes made by those of ordinary skill in the art without departing from the spirit and scope of the present disclosure shall fall within the scope of the application defined by the appended claims.

What is claimed is:

1. A method for analyzing tunnel clearance based on a laser point cloud, comprising:
1) obtaining a point cloud of a tunnel;
2) fitting a cylinder using the point cloud of the tunnel; extracting a central axis of the tunnel; and intercepting a section of the tunnel based on the central axis of the tunnel;
3) extracting point cloud subsets of two rails;
4) constructing a base line of a contour of the tunnel clearance; and extracting a center of the section of the tunnel; and registering a point cloud of the section of the tunnel and a point cloud of the tunnel clearance based on a constraint condition; and
5) analyzing the point cloud of the section of the tunnel and the point cloud of the tunnel clearance which a registered with each other to determine whether the tunnel clearance is intruded.

2. The method of claim 1, wherein the step 1 comprises:
scanning the tunnel using a three-dimensional laser scanner to obtain the point cloud of the tunnel; and
intercepting the point cloud of the tunnel in sections.

3. The method of claim 2, wherein each section containing 10 rings,

4. The method of claim 1, wherein the step 2 comprises:
21) fitting a cylinder using the point cloud of the tunnel through Gaussian mapping to extract a central axis of the tunnel;
22) intercepting the point cloud of a single section of the tunnel based on a point p in the point cloud and an axis direction of the point to construct a section plane; and
23) projecting the point cloud of the section of the tunnel along the extracted central axis of the tunnel to obtain two-dimensional section data.

5. The method of claim 1, wherein the step 3 comprises:
extracting point clouds of the two rails from the point cloud of the tunnel;
selecting points pᵢ and pⱼ from point clouds of the two rails; and
clustering point cloud subsets of the two rails using Euclidean distance.

6. The method of claim 1, wherein the constraint condition in the step 4 is obtained is obtained by steps of:
selecting the highest points z_maxᵢ and z_maxⱼ of the point clouds of the two rails to construct a straight line l; calculating a slope k of the straight line l;
fitting a circle using Random Sample and Consensus (RANSAC) method according to the point cloud of the section of the tunnel to obtain a center c of the circle and an abscissa c·x of the center of the circle; and
setting two constraint conditions: a) a bottom edge of a bound box of a clearance contour coincides with the straight line l; and b) an abscissa c₀·x of a center of the clearance contour is the abscissa c·x of the center of the circle.

7. The method of claim 1, wherein the step 5 comprises:
for a point p_i in the center of the point cloud of the tunnel section, searching the closest point p_in in the point cloud of the clearance contour through K-Nearest Neighbors (KNN); and determining whether the tunnel clearance is intruded through an intrusion function:
S=∥p_i−c∥−∥p_in−c∥,
wherein, p_i is any point in the point cloud of the section of the tunnel; p_in is the closest point searched by KNN in the point cloud of the clearance contour; when S<0, the tunnel clearance is intruded; otherwise, the tunnel clearance is not intruded.

8. A device for analyzing tunnel clearance based on a laser point cloud, comprising:
a data acquisition module, configured to acquire a point cloud of a tunnel;
a preprocessing module, configured to preprocess the point cloud of the tunnel, intercept segments, and extract a central axis of the tunnel and point cloud subsets of a rail; wherein the point cloud subsets are for registration of the point cloud; and
an analysis module, configured to calculate a straight line and a center of the tunnel, and register a point cloud of a clearance contour with a point cloud of a section of the tunnel through constraint conditions to analyze the tunnel clearance.

9. The device of claim 8, wherein the preprocessing module comprises:
an interception unit, configured to intercept the point cloud of the tunnel into segments; and
an extraction unit, configured to extract the point cloud subsets of the rails from the point cloud of the tunnel and and perform clustering for the point cloud subsets of the two rails using Euclidean distance, so as to extract the point cloud subsets of the two rails.

10. A system for analyzing tunnel clearance based on a laser point cloud, comprising:
a three-dimensional scanner;
a processor;
a storage; and
a program, stored on the storage, for executing the method of claim 1;
wherein the system is mounted on a tunnel inspection vehicle; and
the three-dimensional scanner is connected to the processor, and is configured to scan the tunnel to obtain point cloud of the tunnel and send the obtained point cloud of the tunnel to the processor.
